(19) United States
(12) Patent Application Publication
(10) Pub. No.: US 2013/0154960 A1
(43) Pub. Date: Jun. 20, 2013

(54) TOUCH DISPLAY DEVICE AND CONTROL METHOD THEREOF TO STOP ACCIDENTAL PROGRAM

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/334,107

(22) Filed: Dec. 22, 2011

(30) Foreign Application Priority Data
Dec. 14, 2011 (CN) 201110418338.5

(51) Int. Cl. G06F 3/041

(52) U.S. Cl. 345/173

(57) ABSTRACT

A touch display device includes a touch display, a touch driver, and a processor. The touch display displays a first control interface having a plurality of program icons. The touch display is configured to receive touch operations having a slide touch with a sliding distance. The touch driver generates an execution command when that the sliding distance is shorter than or equal to a predetermined distance, and generates a sliding command when that the sliding distance is longer than the predetermined distance. The processor receives the execution command and the sliding command The processor controls the touch display to display the second control interface according to the sliding command The processor loads a selected program into a RAM according to the execution command. The processor stops loading the selected program when the touch display receives a predetermined touch operation in the period of loading the selected program.

### BACKGROUND

1. Technical Field

The present disclosure relates to touch display devices, and more particularly, to a touch display device and a control method of the touch display device to stop an accidental program.

2. Description of Related Art

Touch display devices are widely used in all kinds of our lives, such as smart phones and portable computers. A typical touch display device is configured to display control interfaces which have a plurality of program icons. However, when a user touches a touch display to exchange the control interfaces, an icon of the control interface may be accidently touched and an unwanted program related to the touched program icon is executed.

Thus, a new touch display device is desired to overcome the above-described shortcomings

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a touch display device according to one embodiment of the present disclosure.

FIGS. 2A-2B are schematic diagrams of a first control interface and a second control interface displayed by the touch display device of FIG. 1 according to one embodiment.

FIG. 3 is a schematic diagram of a program loading interface displayed by the touch display device of FIG. 1 according to one embodiment.

FIGS. 4-5 are schematic diagrams showing two different predetermined touch operations applied to the program loading interface of FIG. 3.

FIG. 6 is a flowchart showing a control method according to one embodiment of the present disclosure using the touch display device of FIG. 1.

### DETAILED DESCRIPTION

Reference will now be made to the drawings to describe various inventive embodiments of the present disclosure in detail, wherein like numerals refer to like units throughout.

In general, the word “detector” and “generator”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

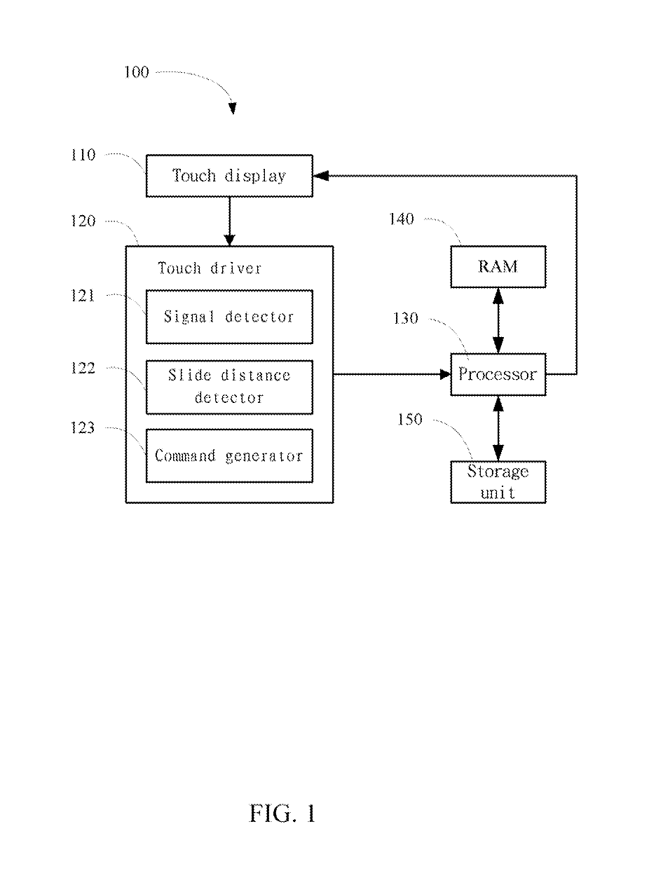

Referring to FIG. 1, a block diagram of a touch display device 100 according to one embodiment of the present disclosure is shown. The touch display device 100 may be a mobile phone or a portable computer, for example a mobile phone.

In one embodiment, the touch display device 100 includes a touch display 110, a touch driver 120, a processor 130, a random access memory (RAM) 140, and a storage unit 150.

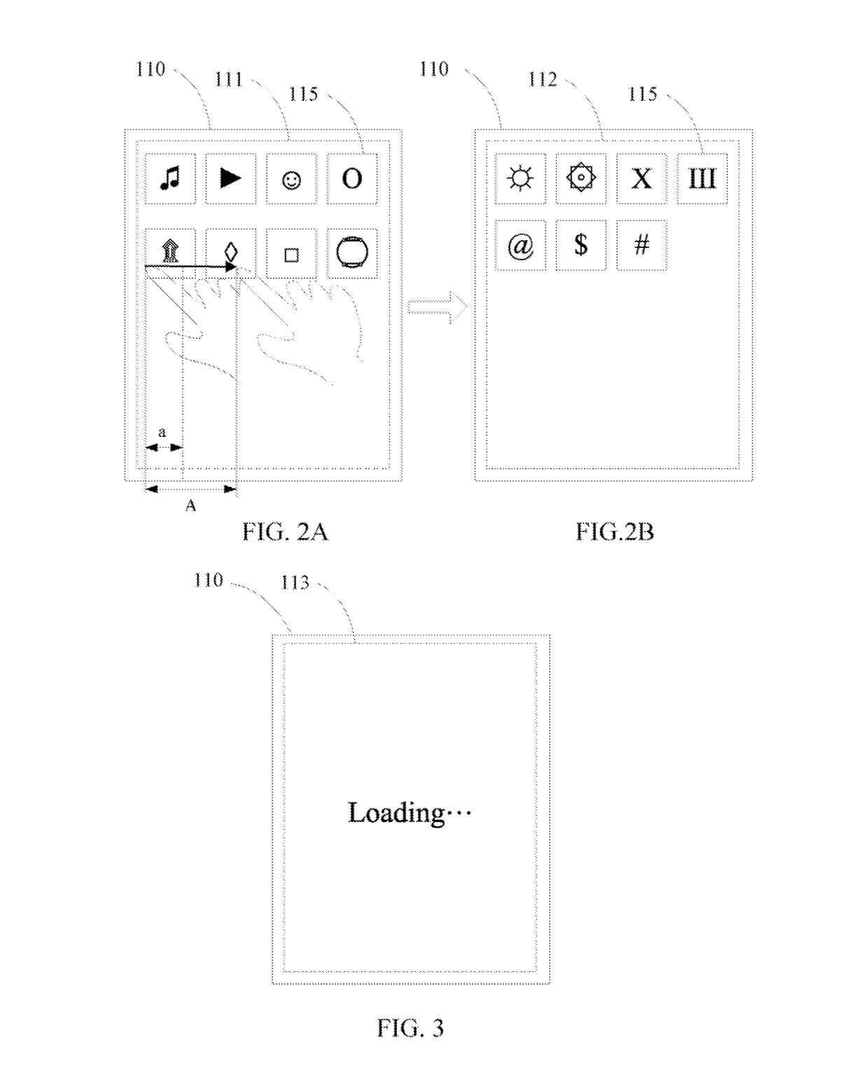

FIG. 2A-2B shows the touch display 110 configured to display a plurality of control interfaces and receive various touch operations to generate touch signals. In one embodiment, the control interfaces include a first control interface 111 and a second control interface 112. Each of the first and the second interface 111, 112 includes a plurality of program icons 115 arranged in lines and rows. In this embodiment, the program icons 115 can be square, rectangle, or circular. One of the first control interface 111 and the second control interface 112 which is being displayed by the touch display 110 is defined to be a current interface. The control interfaces 111, 112 are interfaces that allow a user to press the touch display 110 by his/her finger or a touch pen in accordance with the program icons 115 of the control interfaces 111, 112 to perform a corresponding touch control function.

In this embodiment, the touch display 110 may be a resistance type touch display or capacitance type touch display and can detect various kinds of touch operations, such as a single touch and a slide touch (defined below), when an operator presses the touch display 110 with his or her finger or a touch pen.

The touch driver 120 is configured to detect the types of the touch operations and generate a plurality of commands according to the types of the touch operations. In one embodiment, the touch driver 120 includes a signal detector 121, a slide distance detector 122, and a command generator 123.

The signal detector 121 receives the touch signals from the touch display 110 and determines the types of touch operations according to the received touch signals. In one embodiment, the signal detector 121 defines a touch operation to be a single touch when the operator presses the touch display 110 with one of his or her fingers only at one position. The signal detector 121 defines a touch operation to be a slide touch when the operator continuously contacts the touch display 110 with one of his or her fingers along a sliding distance, for example, “A” as shown in FIG. 2A.

The slide distance detector 122 is configured to confirm a direction and a sliding distance of each of the slide touches to determine if the sliding distance “A” is longer than a predetermined distance “a” along a predetermined direction. In one embodiment, the predetermined direction may be parallel or slant to a side of the touch display 110 or a diagonal of the touch display 110. In one embodiment, the predetermined distance “a” is no more than a length of the program icons 115 at the predetermined direction.

The command generator 123 is configured to generate different commands according to the types of the touch operations by considering the sliding distances “A” and the direction, and transmit the commands to the processor 130. In one embodiment, the command generator 123 generates an execution command when a single touch is detected by the signal detector 121. The command generator 123 may generate the execution command when a slide touch which has a sliding distance “A” shorter than or equal to the predetermined distance “a” is detected by the signal detector 121. The command generator 123 further generates a sliding command when a slide touch which has a sliding distance “A” longer than the predetermined distance “a” is detected by the signal detector 121.

The processor 130 is configured to generate a plurality of control interfaces and transmit the control interfaces to the touch display 110. The processor 130 is also configured to perform predetermined functions according to the received commands.

In one embodiment, the processor 130 controls the touch display 110 to display one of the first control interface 111 and the second control interface 112 instead of the current interface according to the sliding command. The processor 130 loads a selected program into the RAM according to the execution command. The selected program is related to a program icon 115 which is located at or most adjacent to a position of the slide touch applied to the touch display 110. The processor 130 also generates a loading interface as shown in FIG. 3 and transmits the loading interface 113 to the touch display 110 when the selected program is being loaded. The touch display 110 displays the loading interface 113 instead of the current interface according to the execution command. In an alternative embodiment, the loading interface 113 is not limited to the interface as shown in FIG. 3 and may be set to other desired interface. In other alternative embodiment, the loading interface 113 may also be omitted to display nothing when the selected program is being loaded.

In the period of loading the selected program, the command generator 123 of the touch driver 120 further generates a stop command and transmits the stop command to the processor 130 under the condition that the touch display 110 receives a predetermined touch operation within a predetermined time. The processor 130 stops the process of loading the selected program and regenerates the one of the first control interface 111 and the second control interface 112 that is previously instead by the loading interface 113. The touch display 110 displays the regenerated one of the first control interface 111 and the second control interface 112 instead of the loading interface 113 according to the stop command.

The processor 130 completes loading the selected program and executes the program under the condition that the touch display 110 does not receive the predetermined touch operation within the predetermined time. At the same time, the processor 130 generates a program interface according to the executed program and transmits the program interface to the touch display 110. The touch display 110 displays the program interface when the selected program is being executed by the processor 130. In one embodiment, the predetermined time may be set to 2-3 seconds.

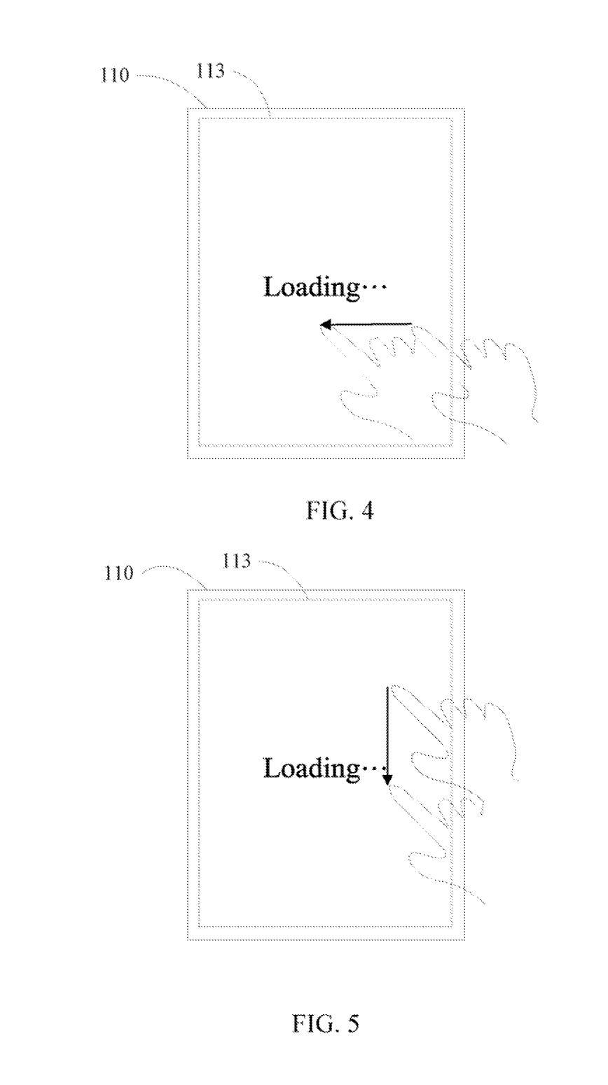

In one embodiment, the predetermined touch operation may be touching the touch display in a same area two or three times. The predetermined touch operation may also be a slide touch with a reversed direction as shown in FIG. 4 or with a perpendicular direction as shown in FIG. 5 relating to a last slide touch as shown in FIG. 2A.

In one embodiment, the storage unit 150 may be a hard disc, a flash memory, a CD-ROM or the like and configured to store some parameters of the interfaces, the program icons, the programs related to the program icons and other needed data.

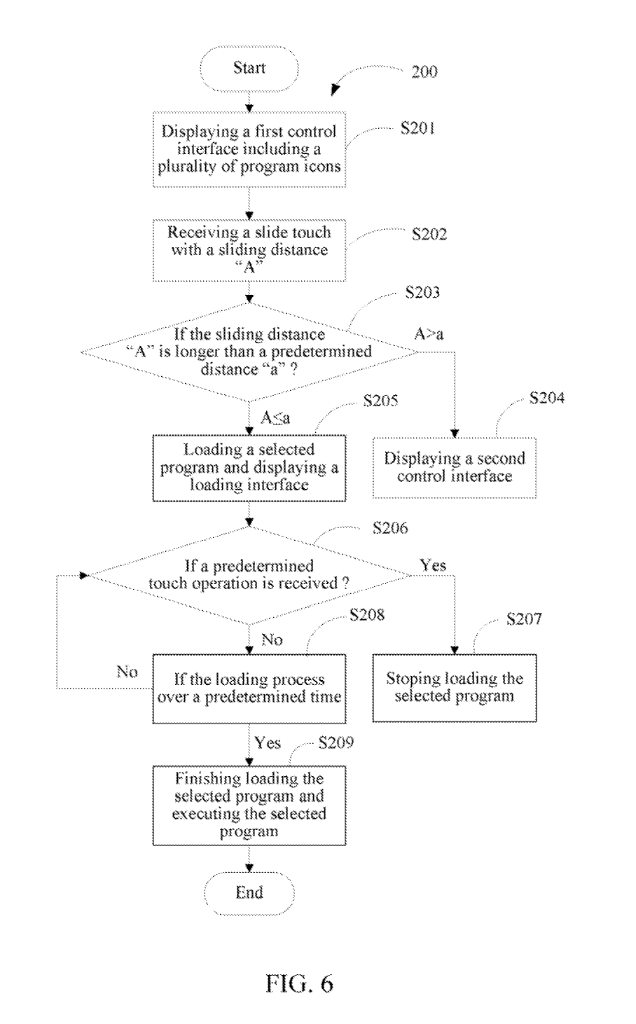

Referring to FIG. 6, a control method according to one embodiment of the present disclosure using the touch display device 100 is shown. The control method includes the following steps, but it should be understood that in other embodiments, additional steps may be added, others deleted, and the ordering of the steps may be changed.

In step S201, the first control interface 111 including a plurality of program icons 115 is displayed on the touch display 110.

In step S202, the touch display 110 receives a slide touch with a sliding distance “A” along a predetermined direction.

In step S203, the touch driver 120 determines if the sliding distance “A” is longer than a predetermined distance “a”. In one embodiment, the predetermined distance “a” is less than a length of the program icons 115 at the predetermined direction.

In step S204, the touch display 110 displays the second control interface 112 instead of the first control interface 111 when the sliding distance “A” is longer than the predetermined distance “a”.

In step 205, the processor 130 loads a selected program into the RAM 150 when the sliding distance “A” is not longer than the predetermined distance “a”. In one embodiment, the processor 130 may generate a loading interface 113 and transmits the loading interface 113 to the touch display 110 during the loading progress. The touch display 110 displays the loading interface 113 instead of the first control interface 111. In one embodiment, the selected program is related to a program that is located at or most adjacent to the position of the slide touch.

In step S206, the touch driver 120 determines if the touch display 110 receives a predetermined touch operation in the period of loading the selected program. In step S207, the processor 130 stops loading the selected program when the touch display 110 receives the predetermined touch operation within a predetermined time in the period of loading the selected program.

In step S208, the processor 130 determines if the loading process is over the predetermined time. In step S209, the processor 130 completes loading the selected program and executes the selected program when the loading process is over the predetermined time. At the same time, the processor 130 generates a program interface according to the executed program and transmits the program interface to the touch display 110. The touch display 110 displays the program interface instead of the loading interface 113 when the selected program is being executed by the processor 130. In one embodiment, the predetermined time may be set to 2-3 seconds.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A touch display device, comprising:
a random access memory (RAM);
a storage unit;
a touch display that displays a first control interface that receives touch operations, the first control interface comprising a plurality of program icons, the touch operations comprising a slide touch with a sliding distance;
a touch driver that generates an execution command under the condition that the sliding distance is shorter than or equal to a predetermined distance, and generates a sliding command under the condition that the sliding distance is longer than the predetermined distance; and
a processor configured to receive the execution command and the sliding command, control the touch display to display a second control interface on the touch display instead of the first control interface according to the sliding command, and load a selected program that is related to one slide touched program icon into the RAM according to the execution command,
wherein the processor stops loading the selected program when the touch display receives a predetermined touch operation in the period of loading the selected program.

2. The touch display device of claim 1, wherein the predetermined touch operation is indicative of a user touching the touch display two or three times in a same area of the touch display.

3. The touch display device of claim 1, wherein the predetermined distance is calculated along a predetermined direction reversed to a last slide touch of the touch display.

4. The touch display device of claim 3, wherein the predetermined direction is parallel to a side or a diagonal of the touch display.

5. The touch display device of claim 1, wherein the processor also generates a loading interface and controls the touch display to display the loading interface on the touch display instead of the first control interface when the selected program is being loaded.

6. The touch display device of claim 5, wherein the processor stops loading the selected program when the touch display receives the predetermined touch operation within a predetermined time.

7. The touch display device of claim 6, wherein the processor completes loading the selected program and executes the selected program when the loading process is over the predetermined time.

8. The touch display device of claim 7, wherein the processor generates a program interface according to the executed program and controls the touch display to display the program interface instead of the loading interface when the selected program is executed.

9. The touch display device of claim 1, wherein the touch driver comprises a signal detector, a slide distance detector, and a command generator.

10. The touch display device of claim 9, wherein the signal detector receives touch signals from the touch display and determines types of the touch operations according to the received touch signals.

11. The touch display device of claim 10, wherein the slide distance detector confirms a direction and the sliding distance of the slide touch.

12. The touch display device of claim 10, wherein the command generator generates different commands according to the types of the touch operations.

13. A control method of a touch display device, comprising:
displaying a first control interface including a plurality of program icons by a touch display;
receiving a slide touch with a sliding distance by the touch display;
displaying a second control interface instead of the first control interface by the touch display when the sliding distance is longer than a predetermined distance;
loading a selected program by a processor if the sliding distance is shorter than or equal to the predetermined distance; and
stopping loading the selected program if a predetermined touch operation is received by the touch display.

14. The control method of claim 13, wherein the predetermined touch operation is indicative of a user touching the touch display two or three times in a same area of the touch display.

15. The control method of claim 13, wherein the predetermined distance is calculated along a predetermined direction reversed to a last slide touch of the touch display.

16. The control method of claim 13, further comprising generating a loading interface by the processor and displaying the loading interface instead of the first control interface by the touch display when the selected program is being loaded.

17. The control method of claim 13, further comprising stopping loading the selected program when the touch display receives the predetermined touch operation within a predetermined time.

18. The control method of claim 17, further comprising completing loading the selected program and executing the selected program when the loading process is over the predetermined time.

19. The control method of claim 13, wherein the selected program is related to one slide touched program icon.
